(19) United States
(12) Patent Application Publication
(10) Pub. No.: US 2004/0068462 A1
(43) Pub. Date: Apr. 8, 2004

(54) Peer-to-peer internet trading system with distributed search engine

(75) Inventors: Neil Katz, Parkland, FL (US); Victor S. Moore, Boynton Beach, FL (US); Lawrence P. O'Connell, Matawan, NJ (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY

(21) Appl. No.: 10/265,835

(22) Filed: Oct. 7, 2002

(51) Int. Cl. G06F 17/60

(52) U.S. Cl. 705/37

(57) ABSTRACT

A decentralized method of negotiating for the exchange of products over a communications network can include generating a request specifying at least one product attribute within a requesting device and forwarding the request to other authorized devices having a presence on the communications network. Each of the devices can include a distributed search engine for locating descriptions of products stored in the devices which match the request. One or more descriptions of products matching the request can be received from selected ones of the authorized devices. The matching descriptions can be stored within the requesting device.

### BACKGROUND OF THE INVENTION

1. Technical Field

The invention relates to the field of electronic commerce and, more particularly, to a decentralized electronic commerce system.

2. Description of the Related Art

Presently, most so called online commerce systems rely upon a centralized business model. That is, commerce and/or trading networks rely upon a client-server model which manages all aspects and information of a transaction within a centralized computer system. The prospective transaction participants log in to the central computer system or “marketplace” to search for products of interest, list products for sale or trade, and manage personal account information.

Although this technique has met with success, the central marketplace model does have disadvantages. One such disadvantage is the significant burden that is placed upon transaction participants. In particular, prior to performing any task related to a transaction, no matter how trivial, both buyers and sellers must first visit and log in to the central marketplace, which traditionally has been implemented as a Web site or an electronic bulletin board. For example, a participant must log in to the marketplace to update personal information, to search for a desired item, to list a particular item for sale, to bid on particular items, and to establish acceptable forms of payment.

Still, even when participants have logged on to the central marketplace, the opportunity for true negotiations between buyer and seller is limited. Most commerce systems rely upon a direct sale model or an auction model, neither of which provide a framework for negotiations that reflects real world barter style transactions between private parties. Such systems simply do not support direct negotiations between a buyer and a seller.

Another disadvantage of the central marketplace model is the significant amount of costly computing resources which are required to implement the marketplace itself. As noted, the central marketplace model has been implemented using a standard Web architecture which requires high speed servers. The servers manage various views of HTML content and must be capable of supporting many, if not all, users registered with the commerce system as well as the potential transactions those users may generate. The standard client-server model also can be expensive with regard to the maintenance and administration of the equipment as well as the data stored within the equipment. For example, centrally managed services and/or registries which refer persons to vendors must be updated continually to avoid providing out of date contact information to service and/or registry users.

### SUMMARY OF THE INVENTION

The present invention provides an alternative solution to conventional centralized commerce systems. In particular, the present invention utilizes peer-to-peer networking technology to place buyer and seller together without using a central data repository for storing product and transaction information. In consequence, the present invention provides a commerce system which facilitates contact between interested parties, yet can be separated from the actual transaction. Accordingly, buyer and seller can freely negotiate with one another. Notably, by abandoning the centralized commerce model, the present invention provides a cost effective and robust commerce system wherein participants can search for products of interest without navigating through a series of Web pages and/or product classification schemes.

One aspect of the present invention can include a decentralized method of negotiating for the exchange of products over a communications network. For example, the method can be performed using peer-to-peer communications. The method can include generating a request specifying at least one product attribute within a requesting device. The request can be forwarded to other authorized devices having a presence on the communication network.

According to one embodiment of the present invention, the request can be forwarded to at least one device in a different geographic region from the requesting device. Notably, the request can be targeted to the different geographic region. Each of the devices which receive the request can include a distributed search engine for locating product descriptions stored in the device which match the request. The search engines can search a designated portion of a data repository of each of the authorized devices to locate the matching product descriptions. Product descriptions matching the request can be received from selected ones of the authorized devices. The matching product descriptions can be stored within the requesting device, which is to be understood as including storing product descriptions within a data store that is communicatively linked to the requesting device.

Notably, the product descriptions can be specified as one or more markup language documents. Additionally, the product descriptions can specify contact information for a user associated with an authorized device having sent the descriptions. For example, the contact information can include, but is not limited to, an electronic mail address, a telephone number, a pager number, and an instant messaging address.

Another aspect of the present invention can include a method of negotiating for the exchange of products over a communications network. The method can include determining which authorized users of a set of authorized users have established a presence on the communications network. A crawler can be configured to search for product descriptions matching a product profile specifying a product and attributes of the product. The crawler can navigate devices of the authorized users which have a presence on the communications network to determine the matching product descriptions.

The crawler can search for the product descriptions in designated portions of data repositories of the devices of the authorized users. Notably, the crawler can be disposed or based in the originating user device. Alternatively, the crawler can be disposed in a server communicatively linked to the communications network. In that case, the method can include receiving the product profile from the device of the originating authorized user.

The matched product descriptions can be returned to, and stored in a device of the originating authorized user. The product descriptions can specify contact information for a user associated with an authorized device having sent the matched product descriptions. As mentioned, the contact information can include an electronic mail address, a telephone number, a pager number, and an instant messaging address.

Another aspect of the present invention can include a peer-to-peer trading client configured to send and receive product descriptions and product requests. The trading client can include one or more markup language documents specifying product descriptions having at least one attribute of a particular product. The trading client also can include a search engine disposed therein which is configured to search the markup language documents for product attributes matching a received product request. The trading client can send at least a matching one of the markup language documents to a requesting peer-to-peer trading client. The trading client further can include a network crawler configured to search other peer-to-peer trading clients for product descriptions.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating a peer-to-peer network configuration for use with the inventive arrangements disclosed herein.

FIG. 2 is a flow chart illustrating a method of gathering product information corresponding to a user specified request over a communications network according to the inventive arrangements disclosed herein.

FIG. 3 is a flow chart illustrating another method of gathering product information corresponding to a user specified request according to the inventive arrangements disclosed herein.

### DETAILED DESCRIPTION OF THE INVENTION

The present invention provides a distributed buyer/seller model where transaction participants can operate as independent merchants. Peer-to-peer communications concepts are used which allow individual users to buy, sell, and/or trade products independently of a centralized commerce system. A distributed search engine concept is incorporated with the peer-to-peer architecture such that queries for products can be distributed throughout the network. Accordingly, rather than using a centrally managed index, matches to the product queries can be determined individually by each respective participating device.

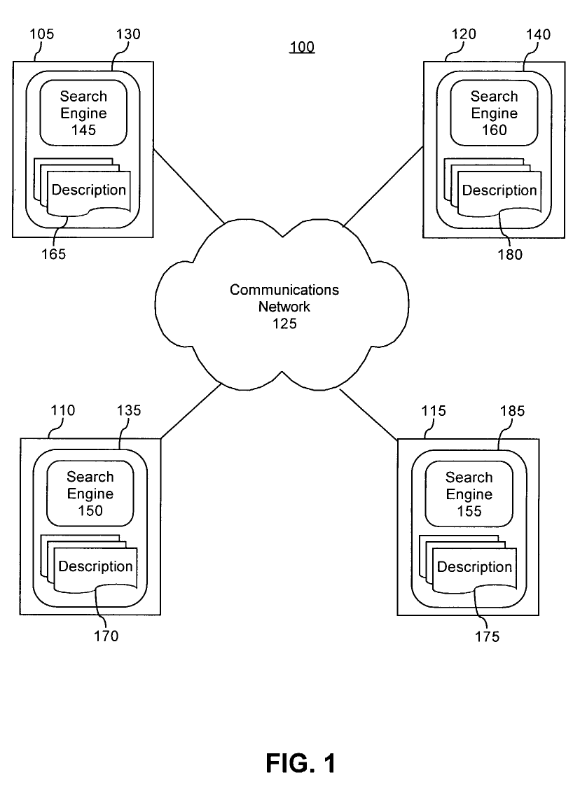

FIG. 1 is a schematic diagram illustrating a peer-to-peer network configuration 100 for use with the inventive arrangements disclosed herein. As shown in FIG. 1, the system 100 can include several network devices 105, 110, 115, and 120, each of which can be communicatively linked via the communications network 125. The system 100 also can include one or more distributed trade enablement (DTE) clients 130, 135, 140, and 185, each disposed within a respective network device.

The network devices 105-120 can include, but are not limited to, any computing device capable of exchanging information over a communications network. For example, the network devices 105-120 can include personal digital assistants which are enabled for wired or wireless communications, wired or wireless telephones, computer systems, and the like. Each of the DTE clients 130, 135, 140, and 185 can include a distributed search engine 145, 150, 155, and 160 respectively, as well as one or more product descriptions 165, 170, 175, and 180.

Each DTE client can be configured as a peer-to-peer networking client which can receive requests forwarded from other ones of the DTE clients for product descriptions matching a specified product profile. The search engines can be configured to search predetermined memory locations, such as directories, within the host network device or DTE client to determine whether any stored product descriptions match received requests. Any matched product descriptions can be forwarded to the DTE client that initially forwarded the request to the receiving network device and DTE client.

Each user can author one or more product descriptions for products that the user desires to sell or trade. The authored product descriptions, in particular product descriptions 165-180, can be stored within each user's network device. Although the product descriptions can be specified and stored using a proprietary format, according to one embodiment of the present invention, the product descriptions can be specified as one or more markup language documents. For example, the product descriptions can be specified using extensible markup language (XML) or a subset thereof for use with transactions between trading partners and/or buyers and sellers. Product descriptions also can be specified using Trading Partner Agreement Markup Language (TPAML) or a derivative thereof. TPAML was developed by International Business Machines Corporation of Armonk, N.Y., and was submitted for standardization to the OASIS XML.ORG initiative.

The product descriptions can specify the items which a user desires to list for sale or trade as well as the desired selling price or an acceptable trade equivalent. For example, products or items can include articles of manufacture as well as programmatic material such as software and data. Additional descriptive attributes can be included as may be required for the particular product being listed. The product descriptions can be generated through the use of a tool which relieves the user from having to manually code a markup language document. The tool can be included as part of the DTE clients. An exemplary listing of possible product and attribute tags is disclosed below:

<Item Category> (Car, Boat, PC Software, Music CD, etc.) </Item>

<Image> </Image>

<Brand Name> </Brand Name>

<Model> </Model>

<Year> </Year>

<Mileage> </Mileage>

<City> </City>

<State> </State

<Price> </Price>

In operation, an authorized and/or registered user can establish a network connection with via network device 110 and the DTE client 135. The user can specify a request for a particular desired product, for example using the product description authoring tool as previously described. Once a request is specified, the DTE client 135 can forward the request to one or more other network devices such as network devices 105, 115, and 120 and the DTE clients disposed therein. Accordingly, the request can be provided to each of the search engines disposed within the respective receiving DTE clients.

Each of the search engines within the various network devices 105, 115, and 120 can search their respective data stores for product descriptions matching the received request. Any matched product descriptions can be provided back to the initiating DTE client 135. The DTE client 135 then can coordinate the various responses. For example, the received product descriptions can be alphabetized, ordered according to price, or organized according to some other product attribute specified in the product descriptions. The results can be stored within a memory store of device 110 for future reference.

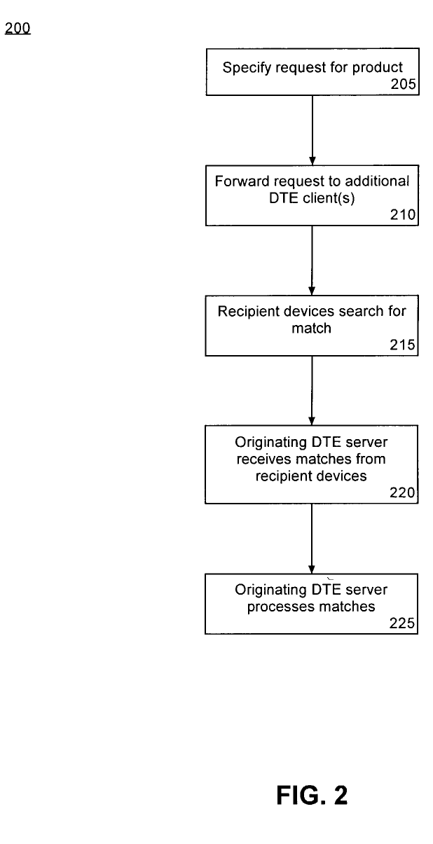

FIG. 2 is a flow chart illustrating a method 200 of gathering product information corresponding to a user specified request over a communications network according to the inventive arrangements disclosed herein. The method 200 can begin in a state wherein a user has registered with a trade and/or commerce system as disclosed herein. For example, the user can pre-register with a trade server such that upon launching a DTE client, the network device or DTE client and associated user can be registered with or log on to the trading server. Still, those skilled in the art will recognize that each respective DTE client can maintain a list of participating users or DTE clients to which requests can be sent. Accordingly, the trade server need not be included.

The method can begin in step 205 where an authorized user can specify a request for a product. As noted the request can be fashioned using an appropriate authoring tool such as the DTE client. For example, a user may want to perform a search for a particular automobile and specify attributes such as the manufacturer, model, number of miles, size, and color of the desired automobile. Notably, the user also can specify quantity and availability parameters for those cases in which the user intends on buying more than one unit of the specified product.

In step 210, the originating DTE client can forward the product request to one or more other DTE clients. For example, the DTE client can be configured to send requests to predetermined addresses specified within a list of participating users or send the request to a particular DTE client which can propagate the request to other users. Alternatively, when an authorized user connects to the communications network, the DTE client can locate one or more DTE clients in close geographic proximity to the requesting DTE client. Techniques for locating other DTE clients in close proximity can include allocating particular IP address ranges to selected DTE clients or identifying a DTE client having a shortest ping response. Similarly, upon establishing a network presence, a DTE client can be configured to ping DTE clients specified in a list to determine whether the DTE clients are available for responding to requests. Notably, the DTE clients can continually monitor for users having an online presence.

According to an alternative embodiment of the invention, as the various DTE clients can be located in a variety of different geographic regions, each DTE client either can include geographic information to be included within responses, or can maintain geographic information of other DTE clients within a locally stored list. Regardless, an originating DTE client can examine a request to identify one or more attributes specified by the requesting user which specify locations to which the request is to be delivered. Accordingly, the originating DTE client can forward the request to those locations which match the user specified location or delivery attributes.

For example, the requesting user may only want to query users located in a particular geographic region. If the user has accessed other local sources such as newspapers, the user can specify that the request be provided only to those users located at least a minimum distance from the requesting user's local region. Alternatively, the requesting user may desire products, for example automobiles, from a specific location such as Florida. Further examples of algorithms that can be used to limit the search can include limiting the search to DTE clients that respond within a minimum latency time, and therefore, are considered to be a minimum distance from the requesting user, limiting the search to particular DTE clients on a fee for service basis, or limiting the search to DTE clients that have proven, in the past, to provide high quality results. Requests also can be forwarded to a multitude of DTE clients. The receiving DTE clients can examine the request and respond only to those requests which are applicable to the receiving DTE client. Thus, a receiving DTE client located outside of a targeted geographic region as specified in a request can ignore the received request.

Accordingly, in step 215, the various network devices having received the product request can search for product descriptions conforming to the received request. Each distributed search engine disposed within a network device can index product descriptions stored locally to that device. The search engines can search for product descriptions within a designated portion of the device data store to determine whether any product descriptions correspond to the received request.

In step 220, the originating DTE client can receive any product descriptions matching the product request from any recipient devices. In step 225, the originating DTE client can process the received product descriptions as previously described. The requesting DTE client can store the results for viewing at a later time. Notably, a received product description can include contact information for the authorized user having provided or authored that product description. For example, the product description can specify a telephone number, a pager number, an electronic mail address, or some other means of contact including an instant messaging user name and/or address, thereby allowing the requesting user to contact the product description provider.

Those skilled in the art will recognize that the present invention facilitates the interaction and contact of persons desiring to buy, sell, and/or trade goods without remaining involved in the resulting transaction. After the matched product descriptions are stored on the requesting user's device, that user can select product descriptions of interest. The product descriptions can be rendered for viewing allowing the requesting user to engage in a non-realtime negotiation with the seller. Notably, a seller can be informed by the DTE client that one or more product descriptions have been provided to a requesting party. For example, the received request can specify contact information for the requesting party which can be provided to the seller via the DTE client. Accordingly, either party to a transaction can initiate contact with the other transaction participants to negotiate and ultimately consummate a transaction.

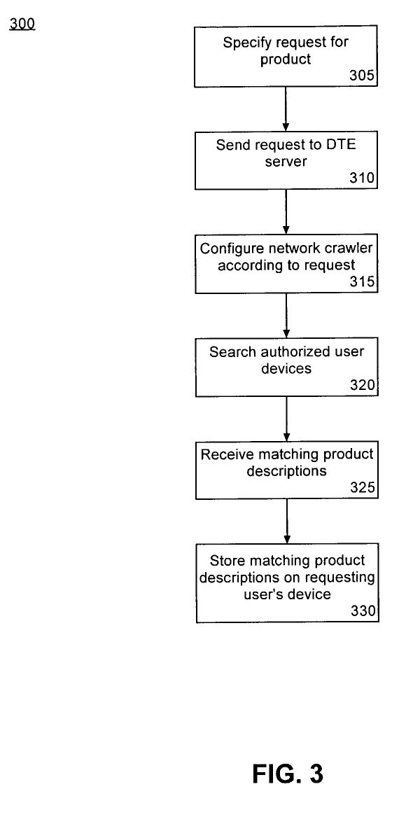

FIG. 3 is a flow chart illustrating another method 300 of gathering product information corresponding to a user specified request according to the inventive arrangements disclosed herein. The method 300 illustrates a non-realtime method of using network crawler technology to systematically search and fetch documents, in this case product description documents, from authorized users. The network crawler can be configured to function in coordination with the DTE clients such that the network crawler can access the portion of memory of a user's network device that is designated for storing product descriptions. Thus, product descriptions corresponding to specified user requests and/or profiles can be identified, indexed, and stored on a requesting user's machine. Although the network crawler can be included as part of a DTE client within a user's network device, according to another embodiment of the present invention, the network crawler can be disposed on a trading server within the communications network.

Accordingly, in step 305, an authorized user can specify a request for a product. The user can specify that the request is to be directed to the network crawler rather than being forwarded to potential transaction participants as previously described with reference to FIG. 2. In step 310, the request can be sent to the trading server. In step 315, the network crawler can be configured according to the received request. Notably, in the case where the network crawler is included as part of the DTE client, the user can configure the network crawler directly. For example, the user can specify a product request to be processed by the network crawler portion of the DTE client.

In any event, in step 320, the network crawler can begin searching the network devices of authorized users for product descriptions matching the specified request. The network crawler can navigate only those network devices which have an online presence and which are registered with the trading service or originating DTE client. The network crawler can search for a predetermine amount of time, if specified by the requesting user, can continually run until requested to stop, or can run until a specified number of product descriptions are located. Regardless, the network crawler can continually index any identified product description matches found on authorized user network devices.

In step 325, the requesting user can receive any matched product descriptions as determined by the network crawler. That is, if the network crawler is disposed within the communications network, the results can be sent to the originating DTE client. If the network crawler is disposed within the DTE client, the results can be returned to the originating DTE client. The matched product descriptions can be provided to the requesting party on a continual basis or when the search has terminated. Regardless, in step 330, the matched product descriptions can be stored on the requesting user's network device for future reference and/or viewing.

The embodiments of the present invention which are disclosed herein serve to reduce transaction costs. By embracing peer-to-peer networking technology, the present invention provides an inherently scalable architecture as quality of service is a function of connection bandwidth, device performance, and not the performance of any centralized data storage or indexing computer system.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A decentralized method of negotiating for the exchange of products over a communications network comprising:
generating a request specifying at least one product attribute within a requesting device;
forwarding the request to other authorized devices having a presence on the communications network, wherein each said device includes a trading client having a distributed search engine for locating descriptions of products stored in said device which match said request;
receiving at least one description of a product matching said request from selected ones of said authorized devices; and
storing said matching descriptions within said requesting device.

2. The method of claim 1, performed using peer-to-peer communications.

3. The method of claim 1, said forwarding step comprising:
forwarding the request to at least one device located in a different geographic region from the requesting device.

4. The method of claim 3, wherein said request is targeted to said different geographic region.

5. The method of claim 1, wherein said search engines search a designated portion of a data repository of each of said authorized devices to locate said matching descriptions.

6. The method of claim 1, wherein said descriptions are specified as at least one markup language document.

7. The method of claim 1, wherein said descriptions specify contact information for a user associated with an authorized device having sent said descriptions.

8. The method of claim 7, wherein said contact information is selected from the group consisting of an electronic mail address, a telephone number, a pager number, and an instant messaging address.

9. A method of negotiating for the exchange of products over a communications network comprising:
determining which authorized users of a set of authorized users have established a presence on the communications network;
configuring a crawler to search for product descriptions matching a product profile specifying a product and attributes of the product;
using the crawler, navigating devices of said authorized users which have a presence on the communications network to determine said matching product descriptions; and
returning said matched product descriptions to a device of the originating authorized user.

10. The method of claim 9, said returning step further comprising:
storing said matched product descriptions in the device of the originating authorized user.

11. The method of claim 10, said navigating step comprising:
searching for the product descriptions in a designated portion of the devices of the authorized users.

12. The method of claim 11, wherein said descriptions specify contact information for a user associated with an authorized device having sent said matched product descriptions.

13. The method of claim 12, wherein said contact information is selected from the group consisting of an electronic mail address, a telephone number, a pager number, and an instant messaging address.

14. The method of claim 9, wherein said crawler is disposed in the device of the originating authorized user.

15. The method of claim 9, wherein said crawler is disposed in a server communicatively linked to the communications network, said method further comprising:
receiving the product profile from the device of the originating authorized user.

16. A peer-to-peer trading client configured to send and receive product descriptions and product requests, said trading client comprising:
a plurality of markup language documents specifying product descriptions having at least one attribute of a particular product; and
a search engine disposed within said peer-to-peer trading client configured to search said plurality of markup language documents for product attributes matching a received product request;
wherein said trading client is configured to send at least a matching one of said markup language documents to a requesting peer-to-peer trading client.

17. The peer-to-peer trading client of claim 16, further comprising a network crawler configured to search other peer-to-peer trading clients for product descriptions.

18. A machine-readable storage, having stored thereon a computer program having a plurality of code sections executable by a machine for causing the machine to perform the steps of:
generating a request specifying at least one product attribute within a requesting device;
forwarding the request to other authorized devices having a presence on the communications network, wherein each said device includes a trading client having a distributed search engine for locating descriptions of products stored in said device which match said request;
receiving at least one description of a product matching said request from selected ones of said authorized devices; and
storing said matching descriptions within said requesting device.

19. The machine-readable storage of claim 18, wherein each of said steps is performed using peer-to-peer communications.

21. The machine-readable storage of claim 18, said forwarding step comprising:
forwarding the request to at least one device located in a different geographic region from the requesting device.

22. The machine-readable storage of claim 21, wherein said request is targeted to said different geographic region.

23. The machine-readable storage of claim 18, wherein said search engines search a designated portion of a data repository of each of said authorized devices to locate said matching descriptions.

24. The machine-readable storage of claim 18, wherein said descriptions are specified as at least one markup language document.

25. The machine-readable storage of claim 18, wherein said descriptions specify contact information for a user associated with an authorized device having sent said descriptions.

26. The machine-readable storage of claim 25, wherein said contact information is selected from the group consisting of an electronic mail address, a telephone number, a pager number, and an instant messaging address.

27. A machine-readable storage, having stored thereon a computer program having a plurality of code sections executable by a machine for causing the machine to perform the steps of:
determining which authorized users of a set of authorized users have established a presence on a communications network;
configuring a crawler to search for product descriptions matching a product profile specifying a product and attributes of the product;
using the crawler, navigating devices of said authorized users which have a presence on the communications network to determine said matching product descriptions; and
returning said matched product descriptions to a device of the originating authorized user.

28. The machine-readable storage of claim 27, said returning step further comprising:
storing said matched product descriptions in the device of the originating authorized user.

29. The machine-readable storage of claim 28, said navigating step comprising:
searching for the product descriptions in a designated portion of the devices of the authorized users.

30. The machine-readable storage of claim 29, wherein said descriptions specify contact information for a user associated with an authorized device having sent said matched product descriptions.

31. The machine-readable storage of claim 30, wherein said contact information is selected from the group consisting of an electronic mail address, a telephone number, a pager number, and an instant messaging address.

32. The machine-readable storage of claim 27, wherein said crawler is disposed in the device of the originating authorized user.

33. The machine-readable storage of claim 27, wherein said crawler is disposed in a server communicatively linked to the communications network, said machine-readable storage further causing the machine to perform the steps of:
receiving the product profile from the device of the originating authorized user.
